(19) United States
(12) Patent Application Publication
(10) Pub. No.: US 2025/0179291 A1
(43) Pub. Date: Jun. 5, 2025

(54) ADDITIVE FOR BONDED MAGNET AND METHOD FOR MANUFACTURING COMPOUND FOR BONDED MAGNET

(71) Applicant: NICHIA CORPORATION, Anan-shi (JP)

(72) Inventor: Satoshi YAMANAKA, Tokushima-shi (JP)

(73) Assignee: NICHIA CORPORATION, Anan-shi (JP)

(21) Appl. No.: 19/046,890

(22) Filed: Feb. 6, 2025

Related U.S. Application Data
(62) Division of application No. 17/629,361, filed on Jan. 21, 2022.

(30) Foreign Application Priority Data
Jul. 22, 2019 (JP) 2019-134528

(51) Int. Cl. C08L 63/00; H01F 1/057; H01F 1/059; H01F 41/02

(52) U.S. Cl. CPC C08L 63/00; H01F 1/057; H01F 1/059; H01F 41/0266

(57) ABSTRACT

The present invention provide an additive for bonded magnets which makes it possible to improve the fluidity of a thermoplastic resin-containing bonded magnet compound, the mechanical properties of a bonded magnet, and other properties, as well as methods of producing a bonded magnet compound or bonded magnet with improved such properties. The present invention relates to an additive for thermoplastic resin-containing bonded magnets containing a cured product of a thermosetting resin and a curing agent having a ratio of the number of reactive groups of the curing agent to the number of reactive groups of the thermosetting resin of at least 2 but not higher than 11.

### CROSS-REFERENCE TO RELATED APPLICATION

This is a divisional application of U.S. patent application Ser. No. 17/629,361, filed Jan. 21, 2022, which is a national phase of PCT/JP2020/023720 filed Jun. 17, 2020, which claims priority to Japanese Patent Application No. 2019-134528 filed on Jul. 22, 2019, all of which are incorporated herein by reference in their entireties.

### TECHNICAL FIELD

The present invention relates to an additive for bonded magnets and a method of producing a bonded magnet compound.

### BACKGROUND ART

Patent Literatures 1 and 2 each disclose a method of producing a bonded magnet by melt-kneading a thermoplastic resin with SmFeN particles, compression molding the mixture to prepare a compound, and injection molding the compound.

Patent Literature 3 discloses a bonded magnet including a NdFeB magnetic powder, an epoxy resin, and an amine-based curing agent for curing the epoxy resin.

### CITATION LIST

### Patent Literature

Patent Literature 1: JP 2017-43804 A
Patent Literature 2: JP 2004-115921 A
Patent Literature 3: JP 2010-232468 A

### SUMMARY OF INVENTION

### Technical Problem

The present invention aims to provide an additive for bonded magnets which makes it possible to improve the fluidity of a thermoplastic resin-containing bonded magnet compound, the mechanical properties of a bonded magnet, and other properties, as well as methods of producing a bonded magnet compound or bonded magnet with improved such properties.

### Solution to Problem

Embodiments of the present invention relate to an additive for thermoplastic resin-containing bonded magnets, containing a cured product of a thermosetting resin and a curing agent having a ratio of a number of reactive groups of the curing agent to a number of reactive groups of the thermosetting resin of at least 2 but not higher than 11.

Embodiments of the present invention relate to a method of producing a bonded magnet compound, the method including: heat-curing a thermosetting resin and a curing agent having a ratio of a number of reactive groups of the curing agent to a number of reactive groups of the thermosetting resin of at least 2 but not higher than 11 to obtain an additive for bonded magnets; and kneading the additive for bonded magnets, a magnetic material, and a thermoplastic resin.

Embodiments of the present invention relate to a method of producing a bonded magnet, the method including: heat-curing a thermosetting resin and a curing agent having a ratio of a number of reactive groups of the curing agent to a number of reactive groups of the thermosetting resin of at least 2 but not higher than 11 to obtain an additive for bonded magnets; kneading the additive for bonded magnets, a magnetic material, and a thermoplastic resin; and injection-molding the resulting bonded magnet compound.

### Advantageous Effects of Invention

According to the above embodiments, it is possible to improve the fluidity of a thermoplastic resin-containing bonded magnet compound, the mechanical properties of a bonded magnet, and other properties.

### DESCRIPTION OF EMBODIMENTS

Embodiments of the present invention are described in detail below. The following embodiments, however, are intended as examples to embody the technical idea of the present invention and are not intended to limit the scope of the present invention to the following embodiments. As used herein, the term “step” encompasses not only an independent step but also a step that may not be clearly distinguished from other steps, as long as a desired object of the step is achieved.

An additive for thermoplastic resin-containing bonded magnets of the embodiments of the present invention contains a cured product of a thermosetting resin and a curing agent having a ratio of the number of reactive groups of the curing agent to the number of reactive groups of the thermosetting resin of at least 2 but not higher than 11. In the conventional production of a bonded magnet containing a thermoplastic resin, when a kneaded mixture of the thermoplastic resin and a thermosetting resin is injection molded, the reactive groups of the thermosetting resin (for example, glycidyl groups of an epoxy resin) may react with the reactive groups of the thermoplastic resin (for example, amide groups of nylon 12), thereby decreasing the fluidity of the resin and deteriorating the moldability. In the cured product of a thermosetting resin and a curing agent at a ratio of the equivalent weight of the curing agent to the equivalent weight of the thermosetting resin of at least 2 but not higher than 11 according to the present embodiments, the reactive groups of the thermosetting resin sufficiently deactivated by the reactive groups of the curing agent (for example, amino groups of diaminodiphenyl sulfone (DDS)) are less likely to react with the reactive groups of the thermoplastic resin, so that the decrease in the fluidity of the resin can be reduced. Such a cured product can be used as an additive for thermoplastic resin-containing bonded magnets. Moreover, when a bonded magnet compound prepared from the additive for thermoplastic resin containing bonded magnets according to the present embodiments is injection molded to form a bonded magnet, this allows the use of a reduced injection pressure and therefore the bonded magnet has enhanced mechanical properties.

Any thermosetting resin that can be cured by heat may be used. Examples include epoxy resins, phenolic resins, urea resins, melamine resins, guanamine resins, unsaturated polyester resins, vinyl ester resins, diallyl phthalate resins, polyurethane resins, silicone resins, polyimide resins, alkyd resins, furan resins, dicyclopentadiene resins, acrylic resins, and allyl carbonate resins. In view of mechanical properties and heat resistance, epoxy resins are preferred among these. The thermosetting resin is preferably a liquid at room temperature or a solid that can be dissolved in a solvent to become liquid.

Any curing agent capable of heat-curing a selected thermosetting resin may be used. When the thermosetting resin is an epoxy resin, examples of the curing agent include amine-based curing agents, acid anhydride-based curing agents, polyamide-based curing agents, imidazole-based curing agents, phenolic resin-based curing agents, polymercaptan resin-based curing agents, polysulfide resin-based curing agents, and organic acid hydrazide-based curing agents. Examples of the amine-based curing agents include diaminodiphenyl sulfone, meta-phenylenediamine, diaminodiphenylmethane, diethylenetriamine, and triethylenetetramine.

The amount of the curing agent is adjusted as a ratio of the number of reactive groups of the curing agent to the number of reactive groups of the thermosetting resin (a ratio of the equivalent weight of the curing agent to the equivalent weight of the thermosetting resin). The ratio of the number of reactive groups of the curing agent to the number of reactive groups of the thermosetting resin is at least 2 but not higher than 11, preferably at least 2 but not higher than 10, more preferably at least 2 but not higher than 7. Moreover, the lower limit of the number of reactive groups is preferably higher than 2.5, more preferably at least 3. When the ratio is higher than 11, the mechanical properties of the bonded magnet may decrease. When the ratio is lower than 2, the ratio of the number of reactive groups of the curing agent to the number of reactive groups of the thermosetting resin may be so small that some reactive groups of the thermosetting resin remain unreacted. In a subsequent step of kneading with a thermoplastic resin, the remaining reactive groups of the thermosetting resin may react with the reactive groups of the thermoplastic resin so that a viscosity increase can occur during injection molding. As a result, the moldability into a bonded magnet and the mechanical properties of the molded article can be deteriorated as compared with when the thermoplastic resin is used alone. Herein, the equivalent weight of the thermosetting resin means the number of grams of resin containing one equivalent of reactive groups, and the equivalent weight of the curing agent means the active hydrogen equivalent weight.

The cured product may be obtained by incorporating the curing agent into the thermosetting resin and heat-curing the mixture. The heat-curing temperature may be selected according to the properties of the thermosetting resin used. From the standpoint of performing heat curing while reducing the magnetic degradation of the magnetic material due to heat, the heat-curing temperature is preferably at least 60° C. but not higher than 250° C., more preferably at least 180° C. but not higher than 220° C.

The cured product may optionally be milled. The cured product may be milled by any method, such as milling with a sample mill, a ball mill, a stamp mill, a mortar, or a mixer. The milled product may optionally be classified with a sieve or other devices. In view of compatibility with the thermoplastic resin, the milled product preferably has an average particle size of not more than 1,000 μm, more preferably not more than 500 μm.

The additive for bonded magnets may also be obtained by incorporating a curing accelerator with the thermosetting resin and the curing agent, and curing the mixture. Examples of the curing accelerator include 1,8-diazabicyclo[5.4.0]undecene-7, 1,5-diazabicyclo[4.3.0]nonene-5, 1-cyanoethyl-2-ethyl-4-methylimidazole, 2-methyl-4-methylimidazole, triphenylphosphine, and sulfonium salts. The amount of the curing accelerator is not limited, but usually the curing accelerator is added in an amount of at least 0.01% by mass but not more than 10% by mass relative to the combined amount of the thermosetting resin and the curing agent.

A method of producing a bonded magnet compound according to the present embodiments includes heat-curing a thermosetting resin and a curing agent having a ratio of the equivalent weight of the curing agent to the equivalent weight of the thermosetting resin of at least 2 but not higher than 11 to obtain an additive for bonded magnets; and kneading the additive for bonded magnets, a magnetic material, and a thermoplastic resin.

The step for obtaining an additive for bonded magnets according to the present embodiments is as described above.

In the kneading step, the additive for bonded magnets, the magnetic material, and the thermoplastic resin may be melt-kneaded to prepare a bonded magnet compound to be injection molded. Any melt-kneading machine may be used, including single screw kneading machines, twin screw kneading machines, mixing rolls, kneaders, Banbury mixers, intermeshing twin screw extruders, and non-intermeshing twin screw extruders. The melt-kneading temperature is not limited, and may be selected depending on the properties of the thermoplastic resin used. The temperature is preferably at least 180° C. but not higher than 250° C.

The thermoplastic resin may be any injection-moldable resin. Examples include nylon resins (polyamide resins); polyolefins such as polypropylene (PP) and polyethylene (PE); polyesters; polycarbonates (PC); polyphenylene sulfide resins (PPS); polyether ether ketones (PEEK); polyacetals (POM); and liquid crystal polymers (LCP). Examples of the nylon resins include polylactams such as nylon 6, nylon 11, and nylon 12; condensates of dicarboxylic acids and diamines such as nylon 6,6, nylon 6,10, and nylon 6,12; polyamide copolymers such as nylon 6/6,6, nylon 6/6,10, nylon 6/12, nylon 6/6,12, nylon 6/6, 10/6,10, nylon 6/6,6/6, 12, and nylon 6/polyether; nylon 6T, nylon 9T, nylon MXD6, aromatic nylons, and amorphous nylons. To balance low water absorption with moldability and mechanical properties, nylon resins are preferred among these, with nylon 12 being particularly preferred.

Any magnetic material may be used. Examples include SmFeN-based, NdFeB-based, and SmCo-based rare earth magnetic materials. In view of heat resistance and the absence of rare metals, SmFeN-based magnetic materials are preferred among these. A SmFeN-based magnetic material may be a nitride having a Th₂Zn₁₇-type crystal structure and containing the rare earth metal samarium (Sm), iron (Fe), and nitrogen (N) as represented by the general formula: SmₓFe_{100·x·y}, preferably wherein x is at least 8.1 at % but not more than 10 at %; y is at least 13.5 at % but not more than 13.9 at %; and the balance is mainly Fe.

A SmFeN magnetic material may be produced by a method disclosed in JP H11-189811 A. A NdFeB-based magnetic material may be produced by a HDDR method disclosed in WO 2003/85147. A SmCo-based magnetic material may be produced by a method disclosed in JP H08-260083 A. Moreover, the magnetic material may be surface-treated with a silane coupling agent by, for example, a method disclosed in Patent Literature 1.

The average particle size of the magnetic material is preferably not more than 10 μm, more preferably not more than 6 μm, still more preferably not more than 4 μm. Herein, the average particle size is defined as the particle size corresponding to the 50th percentile of the cumulative undersize particle size distribution by volume. In view of demagnetization squareness, the magnetic material for use in a bonded magnet compound preferably has a monodisperse particle size distribution.

The magnetic material may be surface-treated with a silane coupling agent. The surface treatment with a silane coupling agent or the like increases binding between the magnetic material and the resins, thereby reducing a viscosity increase during injection molding.

The silane coupling agent is preferably a compound represented by the general formula: X—Si—(OR)ₙ wherein X represents an alkyl group having a polar group at the end; R represents a C1-C3 alkyl group; and n represents an integer of at least 1 but not more than 3, provided that the polar group in X has an amino group, a ureido group, an epoxy group, a thiol group, or a methacryloxy group. When the thermoplastic resin used is a nylon resin, the silane coupling agent is preferably one having an amino group with high affinity for the nylon resin, particularly preferably 3-aminopropyltrimethoxysilane, 3-aminopropyltriethoxysilane, 3-(2-aminoethyl) aminopropyltrimethoxysilane, or 3-(2-aminoethyl) aminopropylmethyltriethoxysilane.

The amount of the magnetic material added in the kneading step, i.e., the amount of the magnetic material in the bonded magnet compound is preferably not more than 93.2% by mass, more preferably at least 75% by mass but not more than 92.5% by mass. When the amount of the magnetic material is more than 93.2% by mass, the viscosity during injection molding may become higher, resulting in a decrease in moldability. When the amount is less than 75% by mass, the remanence of the bonded magnet may decrease.

The amount of the additive for bonded magnets added in the kneading step, i.e., the amount of the additive for bonded magnets in the bonded magnet compound is preferably at least 0.1% by mass but not more than 2.5% by mass, more preferably at least 0.2% by mass but not more than 2.0% by mass. When the amount of the additive for bonded magnets is more than 2.5% by mass, the mechanical properties may decrease. When the amount is less than 0.1% by mass, the effect of addition of the additive for bonded magnets may decrease.

The amount of the thermoplastic resin added in the kneading step, i.e., the amount of the thermoplastic resin in the bonded magnet compound is preferably at least 6.3% by mass, and more preferably at least 7.0% by mass but not more than 24.5% by mass. When the amount of the thermoplastic resin is more than 24.5% by mass, the remanence may decrease. When the amount is less than 6.3% by mass, the viscosity during injection molding may become higher, resulting in a decrease in moldability.

A bonded magnet compound according to the present embodiments can be produced as described above.

A method of producing a bonded magnet according to the present embodiments includes:
heat-curing a thermosetting resin and a curing agent having a ratio of the number of reactive groups of the curing agent to the number of reactive groups of the thermosetting resin of at least 2 but not higher than 11 to obtain an additive for bonded magnets;
kneading the additive for bonded magnets, a magnetic material, and a thermoplastic resin; and
injection molding the resulting bonded magnet compound.

The step for obtaining an additive for bonded magnets and the kneading step are as described above.

In the injection molding step, the bonded magnet compound may be injection molded into an injection molded product. The cylinder temperature of the injection molding machine used may be in any temperature range that can melt the bonded magnet compound, and is preferably not higher than 260° C. in order to reduce the magnetic degradation of the magnetic material due to heat. The injection pressure may be any pressure that can inject the molten compound. For example, for injection molding into a cavity with a width of 10 mm, a thickness of 4 mm, and a length of 80 mm using an injection molding machine at a cylinder temperature of 260° C., the injection pressure is preferably such that the compound can be completely loaded into the cavity at less than 162 MPa in view of moldability.

A bonded magnet of the present embodiments can be produced as described above.

### EXAMPLES

The present invention will be specifically described below with reference to, but not limited to, examples.

The materials used in the examples and comparative examples are listed below.
Epoxy resin: biphenyl type (epoxy equivalent weight: 186 g/eq)
Curing agent: diaminodiphenyl sulfone (DDS, active hydrogen equivalent weight: 62.0 g/eq)
Curing accelerator: triphenylphosphine (TPP)
Magnetic material: surface-treated SmFeN-based magnetic material (average particle size: 3 μm (monodisperse particle size distribution), remanence Br of magnetic powder alone: 1.31 T)

### Production Example 1

An amount of 100 parts by mass of a SmFeN-based magnetic material was surface-treated with 1.875 parts by mass of ethyl silicate and 0.4 parts by mass of 3-aminopropyltriethoxysilane (Z-6011 available from Dow Corning Toray Co., Ltd.) to prepare a surface-treated SmFeN-based magnetic material.

### Example 1

### Preparation of Additive for Bonded Magnets

An amount of 12 parts by mass of an epoxy resin, 8.9 parts by mass of a curing agent, and 0.4 parts by mass of a curing accelerator were dissolved and mixed in 100 parts by mass of acetone. After evaporating the acetone, the mixture was cured using a tray dryer in a nitrogen atmosphere at 200° C. for six hours. The cured product was milled in a mixer and then classified using a 500 μm-aperture sieve to prepare an additive for bonded magnets.

### Preparation of Bonded Magnet Compound

An amount of 100 parts by mass of the surface-treated SmFeN-based magnetic material prepared in Production Example 1 was mixed with 0.5 parts by mass of the additive for bonded magnets and 8.8 parts by mass of polyamide 12, and they were melt extrusion-kneaded using a twin screw kneading machine in a 230° C. atmosphere to obtain a bonded magnet compound.

### Preparation of Bonded Magnet

The bonded magnet compound was injection molded at a cylinder temperature of 260° C., a die temperature of 90° C., and an injection pressure of 152 MPa to obtain a bonded magnet specimen for strength testing having a width of 10 mm, a thickness of 4 mm, and a length of 116 mm.

### Comparative Example 1

An amount of 100 parts by mass of the surface-treated SmFeN-based magnetic material was mixed with 9.2 parts by mass of polyamide 12, and they were melt extrusion-kneaded using a twin screw kneading machine in a 230° C. atmosphere to obtain a bonded magnet compound. Then, a bonded magnet was prepared from the bonded magnet compound as in Example 1. The bending strength of the bonded magnet was measured. Table 1 shows the injection pressure in the injection molding.

### Examples 2 and 3 and Comparative Example 2

Bonded magnet compounds and bonded magnets were prepared as in Example 1, except that the formulation for the preparation of the additive for bonded magnets was changed as shown in Table 1.

Table 1 shows the injection pressures used in the injection molding of a bonded magnet in the examples and comparative examples. Moreover, Table 2 shows the results of measuring the bending strength of each bonded magnet using an Instron universal testing machine.

TABLE 1

| | Formulation of additive for bonded magnets | | | | |
|---|---|---|---|---|---|
| | | | | Equivalent | Injection |
| | Epoxy | Curing | Curing | weight of | pressure |
| | resin | agent | accelerator | curing agent | MPa |
| Example 1 | 12.0 | 8.9 | 0.4 | 2 | 152 |
| Example 2 | 7.5 | 13.9 | 0.4 | 5 | 141 |
| Example 3 | 6.0 | 15.5 | 0.4 | 7 | 141 |
| Comparative | — | — | — | — | 162 |
| Example 1 | | | | | |
| Comparative | 15.0 | 5.5 | 0.4 | 1 | 177 |
| Example 2 | | | | | |

As shown in Table 1, the injection pressures of the compositions of Examples 1 to 3 were lower than those of the compositions of Comparative Examples 1 and 2, demonstrating that the fluidity of a bonded magnet compound is improved when the compound is a composition which contains an additive for bonded magnets containing a cured product of a thermosetting resin and a curing agent having a ratio of the equivalent weight of the curing agent to the equivalent weight of the thermosetting resin that falls within a predetermined range.

TABLE 2

| | Bending |
|---|---|
| | strength |
| | MPa |
| Example 1 | 105.6 |
| Example 2 | 107.1 |
| Example 3 | 102.2 |
| Comparative | 97.9 |
| Example 1 | |
| Comparative | 85.7 |
| Example 2 | |

As shown in Table 2, the bending strengths of the bonded magnets of Examples 1 to 3 were higher than those of the bonded magnets of Comparative Examples 1 and 2, demonstrating that the mechanical properties of a bonded magnet is also improved when the bonded magnet is prepared from the composition which contains an additive for bonded magnets containing a cured product of a thermosetting resin and a curing agent having a ratio of the equivalent weight of the curing agent to the equivalent weight of the thermosetting resin that falls within a predetermined range.

### INDUSTRIAL APPLICABILITY

The additive for bonded magnets according to the present invention may be used to greatly improve the fluidity of a bonded magnet compound and also to improve the mechanical properties of a bonded magnet formed therefrom. The resulting bonded magnet may be suitably used as a composite material or bonded magnet in a motor or other applications.

What is claimed is:

1. A method of producing a bonded magnet compound, the method comprising:
heat-curing a thermosetting resin and a curing agent having a ratio of a number of reactive groups of the curing agent to a number of reactive groups of the thermosetting resin of at least 2 but not higher than 11 to obtain an additive for bonded magnets; and
kneading the additive for bonded magnets, a magnetic material, and a thermoplastic resin.

2. The method of producing a bonded magnet compound according to claim 1,
wherein the thermoplastic resin is a nylon resin.

3. The method of producing a bonded magnet compound according to claim 1,
wherein the magnetic material has a monodisperse particle size distribution.

4. The method of producing a bonded magnet compound according to claim 1,
wherein the magnetic material contains Sm, Fe, and N.

5. A bonded magnet compound produced by the method according to claim 1.

6. A bonded magnet compound, comprising
an additive for bonded magnets;
a magnetic material; and
a thermoplastic resin,
wherein the additive for bonded magnets is a cured product of a thermosetting resin and a curing agent having a ratio of a number of reactive groups of the curing agent to a number of reactive groups of the thermosetting resin of at least 2 but not higher than 11.

7. A method of producing a bonded magnet, the method comprising:
producing a bonded magnet compound by the method according to claim 1; and
injection molding the bonded magnet compound.

8. A bonded magnet produced by the method according to claim 7.

9. A bonded magnet, comprising
an additive for bonded magnets;
a magnetic material; and
a thermoplastic resin,
wherein the additive for bonded magnets is a cured product of a thermosetting resin and a curing agent having a ratio of a number of reactive groups of the curing agent to a number of reactive groups of the thermosetting resin of at least 2 but not higher than 11.
